(19) United States
(12) Patent Application Publication
(10) Pub. No.: US 2025/0065245 A1
(43) Pub. Date: Feb. 27, 2025

(54) A COMPRESSOR-DRIVEN THERMAL SEPARATION PROCESS USING DIFFUSION GAP DISTILLATION AND WICKING, THERMALLY CONDUCTIVE HEAT TRANSFER SURFACES

(71) Applicant: AIL Research Inc., Hopewell, NJ (US)

(72) Inventor: Andrew LOWENSTEIN, Princeton Junction, NJ (US)

(21) Appl. No.: 18/727,788

(22) PCT Filed: Oct. 31, 2023
(86) PCT No.: PCT/US2023/036365

§ 371 Date: Jul. 10, 2024

Related U.S. Application Data
(60) Provisional application No. 63/421,624, filed on Nov. 2, 2022.

(51) Int. Cl. B01D 5/00; B01D 1/22; B01D 1/30; B01D 3/00; F28F 1/32; F28F 17/00

(52) U.S. Cl. CPC B01D 5/006; B01D 1/22; B01D 1/30; B01D 3/007; F28F 1/32; F28F 17/005; F28F 2245/04

(57) ABSTRACT

A thermal distillation apparatus including vertical, planar evaporation surfaces on which a solution flows as thin films and which are the external surfaces of a first heat exchanger within which flows a first fluid that supplies heat to convert at least some of the volatile solvent of the solution to a vapor, vertical, planar condensation surfaces that are external surfaces of a second heat exchanger within which flows the first fluid or a second fluid that absorbs the thermal energy that is released as vapors of the solvent condensed on the condensation surfaces, air at ambient pressure between the condensation surfaces and the evaporation surfaces, means for supplying the solution to the evaporation surfaces, means for collecting the condensed vapors from the condensation surfaces, and means for collecting the unevaporated portion of the solution from the evaporation surfaces.

### RELATED APPLICATIONS

This application is a U.S. national phase application based on PCT/US23/36365, filed Oct. 31, 2023 and entitled A COMPRESSOR-DRIVEN THERMAL SEPARATION PROCESS USING DIFFUSION GAP DISTILLATION AND WICKING, THERMALLY CONDUCTIVE HEAT TRANSFER SURFACES, which in turn claims priority to and the benefit of U.S. Provisional Patent Application No. 63/421,624, filed Nov. 2, 2022 and entitled COMPRESSOR-DRIVEN THERMAL SEPARATION PROCESS USING DIFFUSION GAP DISTILLATION AND WICKING, CONDUCTIVE HEAT TRANSFER SURFACES, the contents of which are incorporated herein by reference in their entirety.

### FIELD OF THE INVENTION

This invention relates to thermal separation processes, and in particular to thermal separation processes for regenerating a liquid desiccant using a temperature differential created by a compressor-driven heat pump.

### BACKGROUND OF INVENTION

Electrically driven heat pumps are an important part of many industrial separation processes. Desalination and brine concentration often use Mechanical Vapor Compression (MVC) driven by heat pumps to extract water vapor from aqueous salt solutions (i.e., brines) by compressing the vapor to increase its saturation temperature and then condensing the high-pressure vapor in a heat exchanger that returns the released heat of vaporization back to the process.

Electrically driven heat pumps have also been proposed for liquid desiccant regeneration, which also is a process in which water is separated from either an aqueous ionic salt solution or an aqueous ionic liquid solution. In June 2021, U.S. Pat. No. 11,029,045 issued to Woods and Kozubal for a liquid desiccant regenerator that (1) heats a liquid desiccant by bringing the desiccant in direct contact with the heat transfer surface of a heat pump's condenser, (2) collects the water vapor released by the heated desiccant in an air stream that flows through the condenser, and then (3) condenses the water by flowing the humid air stream across the cooled surfaces of the heat pump's evaporator. Using this Electrically Driven Desiccant Regenerator (EDDR), Woods and Kozubal claim that a solution of lithium chloride could be concentrated from 35% to 38% at a Moisture Removal Efficiency of 6 kg/kWh.

Relevant to the invention disclosed here is U.S. Pat. No. 9,770,673, in which Lowenstein describes a thermal separation process called Diffusion-Gap Distillation (DGD). As shown in FIG. 1, a separation process using DGD is characterized by (1) a vertical plate with internal channels on which water vapor condenses with the released phase-change energy for condensation preheating feed brine that flows upward within the plate's internal channels, (2) an evaporating surface spaced apart from the vertical plate on which hot brine flows downward, and (3) a source of thermal energy that further heats the brine that exits at the top of the condensing plate to a maximum temperature before the brine is delivered to the evaporating surface. In this DGD configuration with brine preheating (DGD-preheat), the evaporating surface is parallel to and in close proximity to the condensing plate. This close proximity promotes a high flux of water vapor between the two surfaces with only a small difference in the adjacent brine and condensate temperatures.

Also relevant to the invention disclosed here are U.S. Pat. Nos. 7,269,966 and 7,966,841 in which Lowenstein describes a heat and mass exchanger composed of vertically spaced-apart tubes with fins positioned in the spaces between the tubes. A liquid that flows on the external surfaces of fins positioned above a tube, flows off the fins and onto the external surface of the tube where the liquid exchanges heat with a heat transfer fluid flowing within the tube. After exchanging heat, the externally flowing liquid flows off the tube and onto the fins positioned below the tube. Since the only substrate on which the fluid is heated or cooled is the external surface of the tube, the fins can have a low thermal conductivity, preferably below 10 W/m-C. This design is ideally suited for a heat and mass exchanger that uses a corrosive liquid since the fins can be a polymer that resists corrosion. (In this embodiment the tubes must resist corrosion by the liquid, but the tube surface area typically will be much less than the fin surface area so the tubes can be a more expensive, corrosion-resistant metal alloy.)

### SUMMARY OF INVENTION

According to an exemplary embodiment of the present invention, a thermal distillation apparatus for separating a volatile solvent from a solution composed of the solvent and one or more non-volatile components comprises: one or more vertical, planar evaporation surfaces on which the solution flows as thin films, the planar evaporation surfaces being the external surfaces of a first heat exchanger within which flows a first fluid that supplies heat to convert at least some of the volatile solvent to a vapor; one or more vertical, planar condensation surfaces spaced apart and parallel to a corresponding one of the one or more vertical, planar evaporation surfaces, the planar condensation surfaces being the external surfaces of a second heat exchanger within which flows the first fluid or a second fluid that absorbs the thermal energy that is released as vapors of the solvent condense on the condensation surfaces; air at ambient pressure filling the gap between the condensation surfaces and the evaporation surfaces; means for supplying a flow of the solution from a solution feed source to the one or more evaporation surfaces; means for collecting the condensed vapors that flow off the condensation surfaces; and means for collecting the unevaporated portion of the solution that flows off the evaporation surfaces.

According to an exemplary embodiment, the distance between each evaporation surface and corresponding condensation surface is less than 5 mm.

According to an exemplary embodiment, the planar evaporation surfaces have a treatment that wicks the solution.

According to an exemplary embodiment, the treatment is one of the following: hydrophilic or otherwise wettable fibers bonded to the evaporation surfaces by a flocking process; sheets of non-woven fibers bonded or otherwise attached to the evaporation surfaces, where the fibers are hydrophilic or otherwise wettable and are glass, a natural fiber or a synthetic fiber; sheets of a woven fiber or netting bonded or otherwise attached to the evaporation surfaces, where the fibers are hydrophilic or otherwise wettable and are glass, a natural fiber or a synthetic fiber.

According to an exemplary embodiment, the planar condensation surfaces have a treatment that promotes film-wise condensation and inhibits drop-wise condensation.

According to an exemplary embodiment, spacing elements maintain the gaps between the planar evaporation surfaces and the planar condensation surfaces.

According to an exemplary embodiment, surfaces of the spacing elements are hydrophobic or otherwise treated to inhibit wetting by either the solution or the condensed vapor.

According to an exemplary embodiment, the first heat exchanger is the condenser and the second heat exchanger is the evaporator of a heat pump, with the first fluid and second fluid being refrigerant that circulates in the heat pump.

According to an exemplary embodiment, the solution that is supplied to the one or more evaporation surfaces is an aqueous solution of an ionic salt or ionic liquid and the condensed vapor that is collected is water.

According to an exemplary embodiment, each of the first and second heat exchangers comprises tubes within which the refrigerant flows and spaced-apart fins attached to the tubes and in close thermal contact with the tubes, the fins of the first heat exchanger functioning as the vertical, planar evaporating surfaces and the fins of the second heat exchanger functioning as the vertical, planar condensing surfaces.

According to an exemplary embodiment, the bottom edges of the fins that function as evaporating surfaces are sloped so that an unevaporated portion of the solution flows off the fins into a first set of one or more collection troughs; and the bottom edges of the fins that function as condensing surfaces are sloped so that the condensed vapor flows off the fins into a second set of one or more collection troughs that are displaced from the first set of collection troughs.

According to an exemplary embodiment, a solution level in each collection trough is sufficiently high to submerge a portion of each fin at a location where solution is flowing off the fin.

According to an exemplary embodiment, the surfaces of the fins that function as evaporating surfaces have a treatment that wicks the solution, the treatment configured to direct the solution away from locations where the fins are attached to the tubes.

According to an exemplary embodiment, one or more external sections of the tubes between the spaced-apart fins of the first heat exchanger have one or more of the following characteristics: the one or more external sections are hydrophobic or otherwise resistant to wetting; the one or more external sections have a coating that is hydrophobic or otherwise resistant to wetting; the one or more external sections are covered by an annular washer-like element that is hydrophobic or otherwise resistant to wetting; the one or more external sections are covered by collars that are part of the fins, external surfaces of the collars being treated to be hydrophobic or otherwise resistant to wetting.

According to an exemplary embodiment of the present invention, a heat exchanger comprises: a plurality of tubes through which flow a heat transfer fluid; a plurality of spaced-apart, vertically oriented fins with a thermal conductivity greater than 10 W/m-C attached to the tubes and in thermal contact with the tubes, at least some of the plurality of fins with fin surfaces having wicks configured to spread a solution uniformly over the surfaces; gas flowing in gaps between the fins; a means for delivering the solution to the fin surfaces that have wicks; and a means for collecting the solution that flows off the fin surfaces.

According to an exemplary embodiment, the gas that flows in the gap between fins is air and the solution delivered to the fin surfaces that have wicks is a liquid desiccant.

According to an exemplary embodiment, one or more of external sections of the tubes between the spaced-apart fins have one or more of the following characteristics: the one or more external sections are hydrophobic or otherwise resistant to wetting; the one or more external sections have a coating that is hydrophobic or otherwise resistant to wetting; the one or more external sections are covered by an annular washer-like element that is hydrophobic or otherwise resistant to wetting; the one or more external sections are covered by collars that are part of the fins, external surfaces of the collars being treated to be hydrophobic or otherwise resistant to wetting.

According to an exemplary embodiment, the wicks configured to spread a solution uniformly over the fin surfaces are further configured to direct the flow of solution away from locations where the fins are attached to the tubes.

### DESCRIPTION OF FIGURES

The features and advantages of the present invention will be more fully understood with reference to the following, detailed description of illustrative embodiments of the present invention when taken in conjunction with the accompanying figures, wherein:

FIG. 1 is an illustration of the Diffusion-Gap Distillation process in which condensing vapor preheats the feed brine;

FIG. 2 is a diagram of the Diffusion-Gap Distillation process applied to a heat pump with a flat-plate condenser and a flat-plate evaporator according to an exemplary embodiment of the present invention;

FIG. 3A is a top view of the Diffusion-Gap Distillation process in a configuration where the evaporating and condensing surfaces are the fins of separate finned-tube heat exchangers according to an exemplary embodiment of the present invention;

FIG. 3B is an isometric drawing of the Diffusion-Gap Distillation process in a configuration where the evaporating and condensing surfaces are the fins of separate finned-tube heat exchangers according to an exemplary embodiment of the present invention;

FIG. 4 is a sectional view that intersects the fins of a Diffusion-Gap Distillation process in which the evaporating and condensing surfaces are the fins of separate finned-tube heat exchangers according to an exemplary embodiment of the present invention;

FIG. 5A is a top view of a Diffusion-Gap Distillation process showing an example of a liquid bridge that may form between two spaced-apart fins at a location where a tube intersects the fins according to an exemplary embodiment of the present invention;

FIG. 5B is a cross sectional view of a tube taken along the line B-B of FIG. 5A according to an exemplary embodiment of the present invention;

FIG. 6A is a top view of a Diffusion-Gap Distillation process according to an exemplary embodiment of the present invention;

FIG. 6B is a cross sectional view of a tube taken along line C-C of FIG. 6A showing an annular, non-wettable spacer that encircles the tube according to an exemplary embodiment of the present invention;

FIGS. 7A, 7B and 7C show fins each with a different sloped bottom edge according to exemplary embodiments of the present invention;

FIG. 8 is an isometric drawing of the Diffusion-Gap Distillation process in a configuration where the evaporating and condensing surfaces are the fins of separate finned-tube heat exchangers and the bottom edges of the fins direct liquid in collection troughs according to an exemplary embodiment of the present invention; and

FIG. 9 is a graph of the predicted performance of the Diffusion-Gap Distillation process according to an exemplary embodiment of the present invention.

### DETAILED DESCRIPTION

In exemplary embodiments presented herein, the present invention integrates DGD technology into a compressor-based heat pump in which the heat pump's condenser is the only heat source driving the evaporation of water vapor from liquid desiccant and the heat pump's evaporator is the only heat sink accepting the thermal energy released by condensing water vapor. However, all embodiments presented herein could be adapted to other heat sources and heat sinks. For example, the condenser and evaporator of a heat pump, each with an internal flow of refrigerant, could be replaced with a pair of heat exchangers, one with an internal flow of steam or hot water and the other with a flow of cool water. Heat transfer fluids other than steam and water could flow within the pair of heat exchangers.

Furthermore, those familiar with separation processes will recognize that the embodiments presented here in the context of desiccant regeneration are separating a volatile solvent (i.e., water) from a solution mixture composed of the solvent and one or more non-volatile components (i.e., a dissolved ionic salt). Given this general capability, the embodiments could be applied to solutions and liquids that are a different mixture of components with differing volatility, such as seawater, waste brine from reverse osmosis facilities, waste brine produced in oil and gas mining, waste brine from other industrial processes, and mixtures of organic compounds with differing volatility, and where the terms “solution” and “liquid” are used herein interchangeably.

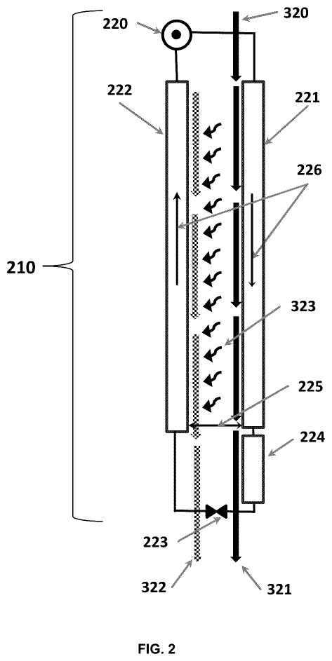

As shown in FIG. 2, one simple exemplary embodiment of the invention operating as a thermal separation apparatus, generally designated by reference number [210], uses a heat pump composed of a compressor [220], a flat-plate condenser [221], a refrigerant subcooler [224], an expansion valve and a flat-plate evaporator to create a thermal sink (i.e., the evaporator [222]) that condenses water vapor and a thermal source (i.e., the condenser [221]) that releases water vapor from a water-rich liquid desiccant that is delivered to the top of the flat-plate condenser and flows down its surface as a thin film that flows off the flat-plate condenser as water-lean liquid desiccant [321]. The evaporator and condenser are disposed parallel to each other with a small air gap between them so that the water vapor released from the liquid desiccant readily moves, either by diffusion or natural convection, across the air gap. The air gap is at ambient pressure which avoids the complications and costs of a pressure vessel that has an internal pressure that differs from ambient. Spacing elements may be used to maintain the evaporator equidistant from the condenser.

In some exemplary embodiments a subcooler for the liquid refrigerant leaving the flat-plate condenser may be used to increase the capacity of the heat pump. Different heat sinks can accept the heat rejected by the subcooler including, but not limited to, ambient air and the cool, water-rich liquid desiccant that is supplied to the thermal separation apparatus [210]. (Depending on whether a subcooler is used and if it is used, its effectiveness, the heat pump may require an auxiliary means to reject heat to ambient so that the total heat rejected to ambient approximately equals the work performed by the compressor. This auxiliary means is not shown.)

Although not shown in FIG. 2, those skilled in the art of liquid desiccant regeneration will recognize that a liquid-to-liquid heat exchanger may be provided that preheats the cool, water-rich liquid desiccant that is supplied to the thermal separation apparatus by recovering thermal energy from the hot, water-lean liquid desiccant that flows off the flat-plate condenser [221].

For a given temperature difference between the high-temperature flat-plate condenser [221] of the heat pump and its low-temperature flat-plate evaporator the quantity of condensed water increases as the size of the air gap between the two heat exchangers decreases. Air gaps that are less than 5 mm are preferred, but not essential.

Different types of flat-plate heat exchangers can be used in the embodiment shown in FIG. 2 including those formed from microchannel extrusions, spot-welded pillow plates, thermally conductive plates with heat transfer tubes bonded to either their faces or edges, or thermally conductive plates with contoured sections within which heat transfer tubes are nested in close thermal contact with the plates, all of which are commonly used in industrial heat pumps. The embodiment in FIG. 2 can also be enlarged to include assemblies of multiple plates in which evaporator plates and condenser plates are spaced apart and interleaved.

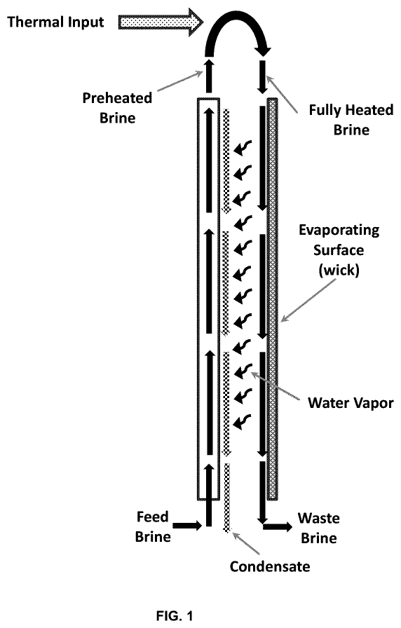

Important differences between the heat-pump DGD process (DGD-HP) in accordance with the exemplary embodiment shown in FIG. 2 and the DGD-preheat process described in U.S. Pat. No. 9,770,673 and shown in FIG. 1 are:

In the DGD-preheat process, the same fluid (e.g., brine) flows within the plate that condenses the water vapor and on the evaporating surface that is the source of water vapor. In the DGD-HP process, different fluids flow within the plate that condenses the water vapor and on the evaporating surface. For example, in the embodiment shown in FIG. 2, a refrigerant flows within the plate that condenses the water vapor and a liquid desiccant flows on the surface that is the source of water vapor.

In the DGD-preheat process, all heating of the brine occurs before the brine is delivered to the evaporating surfaces. During the operation of the DGD-HP process, all or most of the brine heating occurs after the brine is delivered to the evaporating surfaces due to the release of heat from the refrigerant [226].

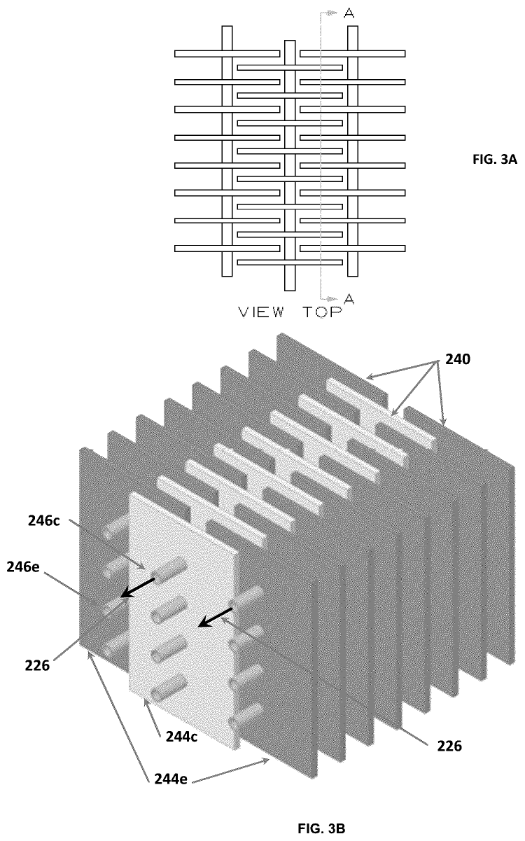

In the exemplary embodiment shown in FIG. 2 both the evaporator and the condenser are vertical flat plates with internal passages that have refrigerant flowing within them. FIG. 3 is a second simplified exemplary embodiment of the disclosed invention in which both the evaporator and the condenser are finned-tube heat exchangers [240] that are similar to the finned-tube heat exchangers commonly used in vapor-compression air conditioners. In these heat exchangers the fins [244e and 244c] are spaced apart along the tubes [246e and 246c], securely attached to the tubes, and in close thermal contact with the tubes so that heat can flow between the tubes and the fins with minimal thermal resistance. The fins for finned-tube heat exchangers commonly are metal with a thermal conductivity greater than 10 W/m-C and have collars that both increase the contact area for heat transfer between the fins and the tubes and keep the fins spaced apart. (An example of a collar for a fin is shown in FIG. 2 of U.S. Pat. No. 3,384,168 by Richter, the contents of which are incorporated herein by reference in their entirety.) Although the fins for finned-tube heat exchangers commonly are metal, they could be a non-metallic material with a thermal conductivity greater than 10 W/m-C.

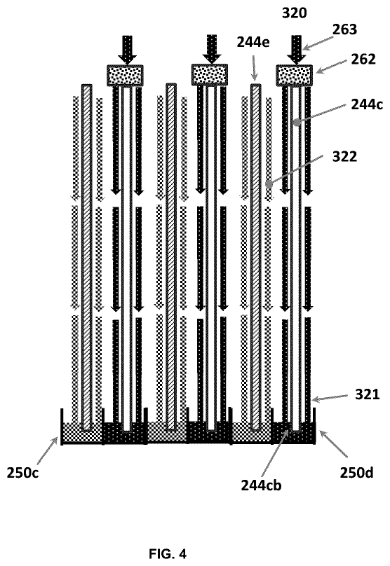

In FIGS. 3A and 3B the fins [244c] of the finned-tube condenser and the fins [244e] of the finned-tube evaporator are both oriented vertically, and the tubes [246c] of the condenser and the tubes [246e] of the evaporator within which refrigerant flows are oriented horizontally. The fins of the evaporator and condenser are interleaved so that except for the outermost fins, a substantial portion of each evaporator fin is located within the air gap between two condenser fins and a substantial portion of each condenser fin is located within the air gap between two evaporator fins. When operating to remove water from a liquid desiccant, films of liquid desiccant (which have been omitted from FIGS. 3A and 3B for simplicity, but do appear in FIG. 4) would flow down the surfaces of the condenser fins [244c] and films of condensed water (again, omitted for simplicity) would flow down the surfaces of the evaporator fins [244e], with water vapor crossing the air gaps from the condenser fins to the evaporator fins.

The cross-section A-A in FIG. 3A intersects 16 fins, eight of which are condenser fins [244c] and eight of which are evaporator fins [244e]. Six neighboring fins in this cross-section are shown in FIG. 4. Shown in FIG. 4 is the water-rich liquid desiccant that is delivered to the condenser fins [244c], flows down the surface of the condenser fins as thin films, and flows off the condenser fins as water-lean liquid desiccant [321]. Also shown in FIG. 4 are the thin films of liquid water that condense on surfaces of the evaporator fins [244e] as water vapor flows across the air gaps from the condenser fins [244c] to the evaporator fins [244e].

Also shown in FIG. 4 are collection troughs [250d] for the concentrated liquid desiccant that flows off the condenser fins and the collection troughs [250c] for the condensate that flows off the evaporator fins. In this figure each trough collects liquid from one aligned fin.

It is important that liquid flows off a fin into its collection trough without creating small droplets that might drift through the air and contaminate a neighboring trough (i.e., a droplet of brine might drift into a trough that collects condensate, thereby contaminating the condensate). A likely mechanism for droplet creation would be for liquid to drip off the bottom edge of a fin and fall into the collection trough. In FIG. 4, this mechanism is avoided by locating the bottom edge of a condenser fin [244cb] under the surface of the water-lean liquid desiccant within its aligned collection trough [250d] so that liquid desiccant flows quiescently from the fins into the collection troughs. In a similar configuration, the bottom edge of each evaporator fin is under the surface of the water within its aligned collection trough.

Also shown in FIG. 4 is a means to deliver desiccant to the condenser fin [244c] consisting of porous, hydrophilic pads located along and in contact with the top edge of the condenser fins. During the operation of the embodiment shown in FIG. 4, desiccant is pumped to discrete delivery points along the pads [262]. Being porous and hydrophilic, surface tension spreads the desiccant throughout the pads and onto the surfaces of the condenser fins [244c]. This design for the desiccant delivery system has the advantage of operating without the creation of droplets.

In the embodiment shown in FIGS. 2, it is important that the desiccant delivered to the flat-plate condenser uniformly wets its external surface that is opposed to the flat-plate evaporator. In the embodiments shown in FIGS. 3 and 4, it is important that the desiccant delivered to the condenser uniformly wets the surfaces of the condenser fins [244c]. In exemplary embodiments, approaches to encouraging uniform wetting of these condenser surfaces include, but are not limited to:
the surfaces are treated so that they are hydrophilic,
the surfaces are flocked with a fiber that is hydrophilic,
thin, wicking layers are bonded to the surfaces.

In applications where thin, wicking layers are bonded or otherwise attached to the surfaces, these layers may be, but are not limited to:
sheets of non-woven, wicking fiberglass;
sheets of non-woven synthetic, wicking fibers such as polyester fibers;
woven fabric with threads that are either natural fibers such as cotton or synthetic fibers such as polyester;
woven meshes with threads that are either natural fibers such as cotton or synthetic fibers such as polyester;
cellulose-based wicking paper.

In applications where a flock or wicking layer is bonded or otherwise attached to a condenser surface, the flock or wicking layer will impose a resistance to heat transfer that adversely effects the performance of the DGD-HP by increasing the temperature lift for the heat pump. To reduce this adverse effect, flock or wicking layers should be the minimum thickness required to uniformly spread the liquid desiccant across the condenser surface. As an example, a 5″ wide, heated surface that was used to regenerate a film of liquid desiccant in the lab required a 35-mil thick layer of non-woven fiberglass to uniformly spread liquid desiccant flowing at 35 ml/min. (This example is illustrative of the thickness of layers that might be needed to uniformly spread a flow of liquid desiccant. However, any particular application of a DGD-HP might require thinner or thicker layers.)

When delivering liquid to two flat, parallel surfaces that are separated by a small gap the liquid may bridge the gap between the two surfaces. Furthermore, bridging is most likely to occur at locations where a third solid surface may connect the two surfaces.

Liquid bridges can be unstable leading to repetitive breaking and reforming of bridges with accompanying droplet formation. As previously explained, droplets can lead to cross contamination between the condensate and the liquid desiccant, which then would seriously compromise the performance of the separation process.

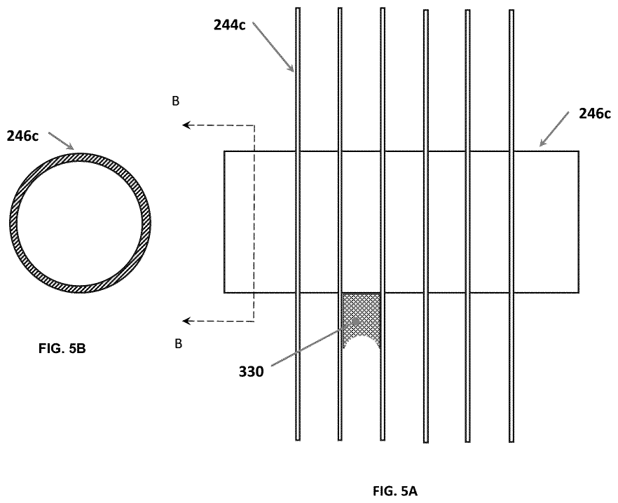

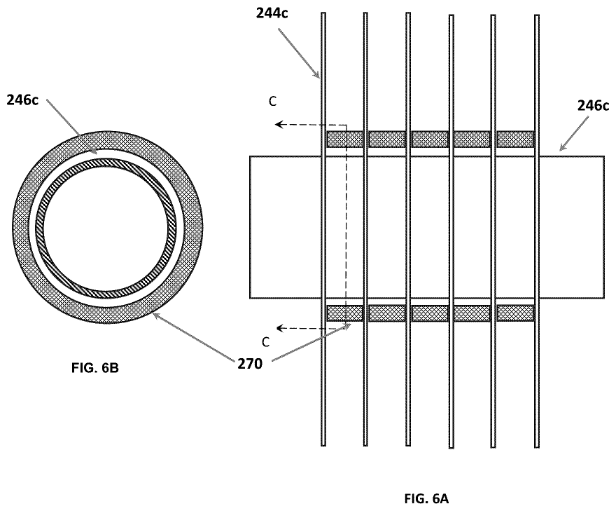

FIG. 5A shows a liquid bridge that might form between the spaced-apart condenser fins [244c] that are part of the embodiment shown in FIGS. 3A and 3B. As shown in FIG. 5A, the liquid bridge is most likely to form in contact with the exposed surface of a tube [246c] that connects spaced-apart condenser fins. Furthermore, a liquid bridge is much more likely to form if the exposed surface of the tube (see outer surface of tube [246c] in the cross-sectional view shown in FIG. 5B) is easily wetted by the liquid, or worse, wicks the liquid. Conversely, tubes with exposed surfaces that are hydrophobic or otherwise difficult to wet will suppress the formation of liquid bridges, as will tubes with exposed surfaces that are covered with a hydrophobic coating. In some applications instead of modifying the exposed surface of the tube it may be preferable to cover the exposed surface with an annular washer-like hydrophobic spacer. FIGS. 6A and 6B show an exemplary embodiment that uses an annular washer-like hydrophobic spacer that encircles a condenser tube [246c] to suppress the formation of liquid bridges that are between condenser fins [244c] and proximate to a condenser tube [246c]. For fins that have collars that increase the contact area between the fins and the tubes (as shown in FIG. 2 of the Richter patent), treating the exposed surfaces of the collars to be hydrophobic will suppress the formation of liquid bridges proximate to the tube.

It will also be advantageous to treat the external surfaces of the evaporator and, if present, its fins so that the condensation of water vapor occurs as thin films, and not as droplets since droplets, if sufficiently large, could span the air gap and lead to the deleterious exchange of liquid between the condenser and the evaporator surfaces. Surface treatments to encourage film-wise condensation of water vapor on the surfaces of conventional HVAC evaporators could be used with the disclosed invention.

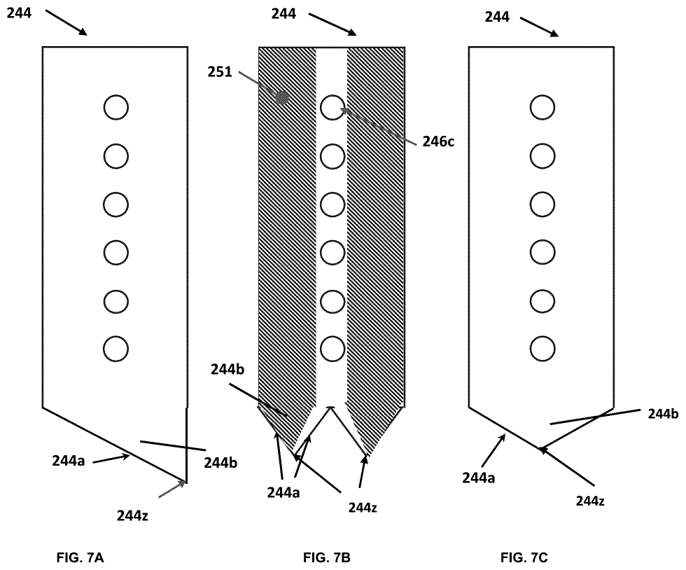

FIGS. 7A, 7B and 7C show three fin configurations according to exemplary embodiments of the present invention that allow a small number of troughs to collect liquid from a multitude of fins without creating liquid droplets. FIG. 7B furthermore shows a wick on the fin surface that directs liquid away from the locations on the fins where tubes penetrate and towards locations where liquid flows off the fins. The bottom portions [244b] of each fin [244] in these figures have one or more sloped edges [244a]. If the angle of the sloped edge relative to the horizontal is sufficiently large, surface tension will keep the liquid that flows downward on the fin attached to the sloped edge [244a] so that the liquid flows along the edge towards the edge's one or more lowest points [244z].

In embodiments in which a flock or wicking layer is bonded or otherwise attached to the fin of a finned-tube condenser, the flock or wicking layer can be configured to direct liquid towards the lowest points [244z] along the sloped edge [244a] of a fin so that the layer further encourages the liquid to flow off the fin at the lowest points. As shown in FIG. 7B, the flock or wicking layer can also be configured to encourage the liquid flow to avoid contact with the tubes [246c] along which the fins are spaced apart, which would further discourage the formation of the liquid bridge that is shown in FIG. 5A.

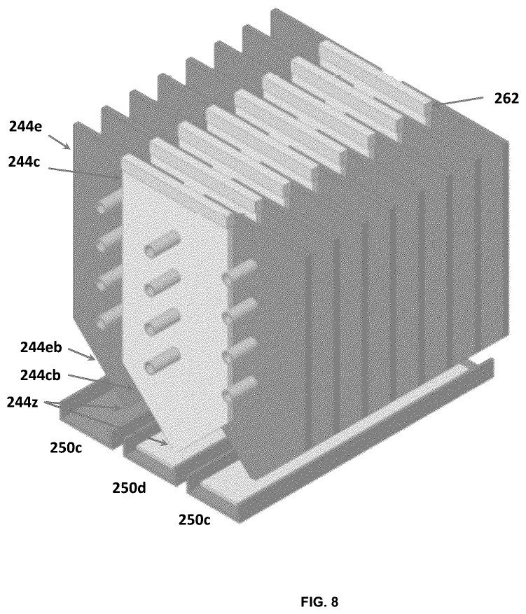

In the assembly of multiple fins shown in FIG. 8, all condenser fins [244c] have identical bottom edges [244cb] with low points [244z] that are aligned. Similarly, all evaporator fins [244e] have identical bottom edges [244eb] with low points [244z] that are aligned, but the alignments are displaced from the alignments for the condensers' low points. As shown in FIG. 8, this displacement of alignments allows linear troughs [250c, 250d] to separately collect the liquid desiccant flowing off the condenser fins and the condensate flowing off the evaporator fins. Furthermore, by locating the troughs so that the low points of each assembly of fins are below the level of liquid in the trough, liquid can be collected without droplet formation.

Also shown in FIG. 8 are the porous pads that were introduced in FIG. 4 as a means of delivering and spreading liquid desiccant along the top edges of condenser fins.

Covering the fins of a finned-tube heat exchanger with a flock or a thin, wicking layer to which a liquid desiccant or other fluid is delivered would be useful in applications other than a thermal distillation apparatus. Furthermore, configurations for these layers that either direct the delivered fluid to a collection trough or direct the liquid desiccant away from tubes or other spacing elements so that liquid bridging between fins is discouraged would be useful in applications other than a thermal distillation apparatus. Useful alternative applications would include those in which the liquid desiccant or other fluid either absorbs a vapor from or desorbs a vapor into air that flows in the gaps between fins.

In embodiments where air flows through gaps between desiccant-wetted fins of a finned-tube heat exchanger, the liquid desiccant may bridge the gap. In addition to increasing the resistance to the flow of air through the heat exchanger, the liquid-desiccant bridges may break leading to the formation of desiccant droplets that can be entrained in the air flow. This entrainment would create maintenance problems, and it should be suppressed.

As previously explained, the formation of liquid-desiccant bridges between two desiccant-wetted surfaces is promoted by spacing elements that themselves are easily wetted by the liquid desiccant. For a finned-tube heat exchanger with fins that have wicking surfaces wetted with desiccant, bridges of liquid desiccant are most likely to form where tubes span the gaps between fins. The means previously described to ensure that exposed tube surfaces do not promote liquid bridges can be applied to finned-tube heat exchangers that have air or other gases flowing in the gaps between fins that are wetted with a liquid desiccant or other liquid.

The operation of the disclosed invention has been described in the context of liquid-desiccant regeneration with no specified use for the liquid desiccant. Other important applications for exemplary embodiments of the invention include, but are not limited to:
A desalting system for seawater or brackish water;
A liquid desiccant regenerator that stores concentrated desiccant;
A liquid desiccant regenerator that is part of an industrial dehumidification system;
A liquid desiccant regenerator that is part of an HVAC cooling system;
A liquid desiccant regenerator that is part of a high efficiency room dehumidifier;
An Atmospheric Water Generator in which a hygroscopic liquid absorbs atmospheric moisture and the invention separates water from the hygroscopic liquid;
A finned-tube heat and mass exchanger with desiccant-wetted fins and air flowing between its fins;

The economic value of the invention can be appreciated by comparing its Moisture Removal Efficiency with that of alternative separation technologies.

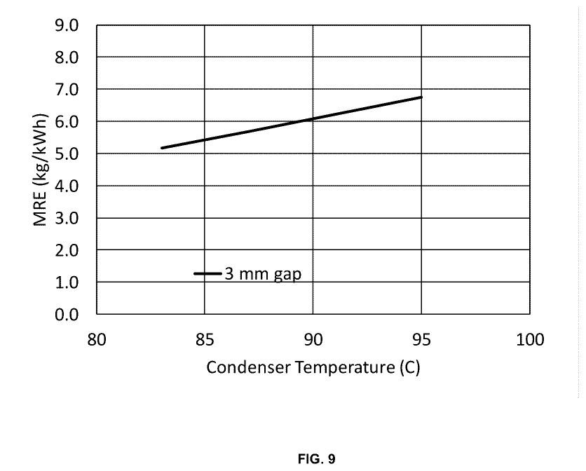

As previously reported Woods and Kozubal predict a 6.0 kg/kWh MRE for their desiccant regenerator (EDDR) when concentrating LiCl from 35% to 38%. As shown in FIG. 9 in a prophetic example, a DGD-HP process in accordance with the present invention concentrating LiCl between the same limits and operating with a 3.0 mm diffusion gap, 95° C. condenser and a compressor with 0.72 isentropic efficiency is predicted, based on a computer simulation, to have an MRE 6.7 kW/kWh. Compared to an EDDR that uses the Woods/Kozubal technology, the DGD-HP EDDR has the additional advantages of (1) recovering 100% of the desorbed water as liquid, and (2) operating without a fan-driven flow of air.

A room dehumidifier manufactured by Quest that removes about 500 pints per day is rated to have a MRE of 3.8 kg/kWh. In a prophetic example, a room dehumidifier using the DGD-HP process in accordance with the present invention that is designed to be a replacement for the Quest unit and operating with a 3.0 mm diffusion gap, 95° C. and a compressor with 0.72 isentropic efficiency is predicted to have a MRE of 6.7 kg/kWh.

Now that embodiments of the present invention have been shown and described in detail, various modifications and improvements thereon can become readily apparent to those skilled in the art. Accordingly, the exemplary embodiments of the present invention, as set forth above, are intended to be illustrative, not limiting. The spirit and scope of the present invention is to be construed broadly.

What is claimed is:

1. A thermal distillation apparatus for separating a volatile solvent from a solution composed of the solvent and one or more non-volatile components, the apparatus comprising:
one or more vertical, planar evaporation surfaces on which the solution flows as thin films, the planar evaporation surfaces being the external surfaces of a first heat exchanger within which flows a first fluid that supplies heat to convert at least some of the volatile solvent to a vapor;
one or more vertical, planar condensation surfaces spaced apart and parallel to a corresponding one of the one or more vertical, planar evaporation surfaces, the planar condensation surfaces being the external surfaces of a second heat exchanger within which flows the first fluid or a second fluid that absorbs the thermal energy that is released as vapors of the solvent condensed on the condensation surfaces;
air at ambient pressure filling the gap between the condensation surfaces and the evaporation surfaces;
means for supplying a flow of the solution from a solution feed source to the one or more evaporation surfaces;
means for collecting the condensed vapors that flow off the condensation surfaces; and
means for collecting the unevaporated portion of the solution that flows off the evaporation surfaces.

2. The thermal distillation apparatus of claim 1, wherein the distance between each evaporation surface and a corresponding condensation surface is less than 5 mm.

3. The thermal distillation apparatus of claim 1, wherein the planar evaporation surfaces have a treatment that wicks the solution.

4. The thermal distillation apparatus of claim 3, wherein the treatment is one of the following:
a. hydrophilic or otherwise wettable fibers bonded to the evaporation surfaces by a flocking process;
b. sheets of non-woven fibers bonded or otherwise attached to the evaporation surfaces, where the fibers are hydrophilic or otherwise wettable and are glass, a natural fiber or a synthetic fiber;
c. sheets of a woven fiber or netting bonded or otherwise attached to the evaporation surfaces, where the fibers are hydrophilic or otherwise wettable and are glass, a natural fiber or a synthetic fiber;

5. The thermal distillation apparatus of claim 4, wherein the planar condensation surfaces have a treatment that promotes film-wise condensation and inhibits drop-wise condensation.

6. The thermal distillation apparatus of claim 1, wherein spacing elements maintain the gaps between the planar evaporation surfaces and the planar condensation surfaces.

7. The thermal distillation apparatus of claim 6, wherein surfaces of the spacing elements are hydrophobic or otherwise treated to inhibit wetting by either the solution or the condensed vapor.

8. The thermal distillation apparatus of claim 1, wherein the first heat exchanger is the condenser and the second heat exchanger is the evaporator of a heat pump, with the first fluid and second fluid being refrigerant that circulates in the heat pump.

9. The thermal distillation apparatus of claim 8, wherein the solution that is supplied to the one or more evaporation surfaces is an aqueous solution of an ionic salt or ionic liquid and the condensed vapor that is collected is water.

10. The thermal distillation apparatus of claim 8, wherein each of the first and second heat exchangers comprises tubes within which the refrigerant flows and spaced-apart fins with a thermal conductivity greater than 10 W/m-C attached to the tubes and in close thermal contact with the tubes, the fins of the first heat exchanger functioning as the vertical, planar evaporating surfaces and the fins of the second heat exchanger functioning as the vertical, planar condensing surfaces.

11. The thermal distillation apparatus of claim 10, wherein the bottom edges of the fins that function as evaporating surfaces are sloped so that an unevaporated portion of the solution flows off the fins into a first set of one or more collection troughs; and the bottom edges of the fins that function as condensing surfaces are sloped so that the condensed vapor flows off the fins into a second set of one or more collection troughs that are displaced from the first set of collection troughs.

12. The thermal distillation apparatus of claim 11, wherein a solution level in each collection trough is sufficiently high to submerge a portion of each fin at a location where solution is flowing off the fin.

13. The thermal distillation apparatus of claim 10, wherein the surfaces of the fins that function as evaporating surfaces have a treatment that wicks the solution, the treatment configured to direct the solution away from locations where the fins are attached to the tubes.

14. The thermal distillation apparatus of claim 10, wherein one or more external sections of the tubes between the spaced-apart fins of the first heat exchanger have one or more of the following characteristics:
a. the one or more external sections are hydrophobic or otherwise resistant to wetting;
b. the one or more external sections have a coating that is hydrophobic or otherwise resistant to wetting;
c. the one or more external sections are covered by an annular washer-like element that is hydrophobic or otherwise resistant to wetting;
d. the one or more external sections are covered by collars that are part of the fins, external surfaces of the collars being treated to be hydrophobic or otherwise resistant to wetting.

15. A heat exchanger comprising:
a plurality of tubes through which flow a heat transfer fluid;
a plurality of spaced-apart, vertically oriented fins with a thermal conductivity greater than 10 W/m-C attached to the tubes and in thermal contact with the tubes, at least some of the plurality of fins with fin surfaces having wicks configured to spread a solution uniformly over the surfaces;
gas flowing in gaps between the fins;
a means for delivering the solution to the fin surfaces that have wicks; and
a means for collecting the solution that flows off the fin surfaces.

16. The heat exchanger of claim 15, wherein the gas that flows in the gap between fins is air and the solution delivered to the fin surfaces that have wicks is a liquid desiccant.

17. The heat exchanger of claim 15, wherein one or more of external sections of the tubes between the spaced-apart fins have one or more of the following characteristics:
a. the one or more external sections are hydrophobic or otherwise resistant to wetting;
b. the one or more external sections have a coating that is hydrophobic or otherwise resistant to wetting;
c. the one or more external sections are covered by an annular washer-like element that is hydrophobic or otherwise resistant to wetting;
d. the one or more external sections are covered by collars that are part of the fins, external surfaces of the collars being treated to be hydrophobic or otherwise resistant to wetting.

18. The heat exchanger of claim 15, wherein the wicks configured to spread a solution uniformly over the fin surfaces are further configured to direct the flow of solution away from locations where the fins are attached to the tubes.
